(19) United States
(12) Patent Application Publication
(10) Pub. No.: US 2014/0026223 A1
(43) Pub. Date: Jan. 23, 2014

(54) MOBILE DEVICE RECORDING

(71) Applicants: Swapnil R. DAVE, Santa Clara, CA (US); Devrim VAROGLU, Santa Clara, CA (US)

(72) Inventors: Swapnil R. DAVE, Santa Clara, CA (US); Devrim VAROGLU, Santa Clara, CA (US)

(73) Assignee: APPLE INC., Cupertino, CA (US)

(21) Appl. No.: 13/556,115

(22) Filed: Jul. 23, 2012

(51) Int. Cl. G06F 21/00

(52) U.S. Cl. 726/26

(57) ABSTRACT

A method for recording between a first device and a second device includes, prior to establishing a connection for recording between the first and second devices, creating a list of trusted devices. Presence of the second device on the list indicates permission to record a communication between the first and second devices. The method further includes storing the list of trusted devices, wherein the list is accessible by the first device, establishing the connection for recording between the first and second devices, verifying by the first device that the second device is on the list of trusted second devices, and recording at least a portion of the communication between the first and second devices if indicated by a user of the first device without further input from a user of the second device.

### FIELD OF THE DESCRIBED EMBODIMENTS

The described embodiments relate generally to mobile devices, and more particularly, to recording at least a portion of communications between mobile devices.

### BACKGROUND

Conventionally, recording devices include digital or analog recording devices which receive audio information and store the same in a conventional format. The recording devices include an audio sampling portion configured to receive audio information, for example, through a microphone. The recording devices also include storage means configured to store sampled audio. The recording devices may also include a playback mechanism whereby the stored audio may be played back to a user.

During a telephone conversation, if it is desired to record the conversation, the audio sampling portion of the conventional recording device must be coupled to a speaker or audio output device of a telephone apparatus such that a portion of the conversation is sampled and subsequently stored at the recording device.

It should be appreciated that as users continue to become mobile through the use of personal electronic devices, there may be a need for increasingly portable recording devices for recording on the go. Moreover, it may be beneficial to distribute portions of stored audio amongst users participating in the recording, for example, amongst two or more users involved in a telephone conversation. Furthermore, given the increasing capabilities of personal electronic devices, it may be beneficial to integrate safe, consensual recording solutions amongst electronic devices.

### SUMMARY OF THE DESCRIBED EMBODIMENTS

This paper describes various embodiments that relate to mobile device recording. Mobile device recording may be facilitated through immediate consent between at least two devices, stored prior consent between at least two devices, and/or implied consent between at least two devices. The mobile device recording may be extensible to more than two devices via communication bridging, and may include storage, manipulation, playback, and distribution of recordings.

According to some embodiments of the present invention, a method for recording between a first device and a second device includes, prior to establishing a connection for recording between the first and second devices, creating a list of trusted devices. Presence of the second device on the list indicates permission to record a communication between the first and second devices. The method further includes storing the list of trusted devices, wherein the list is accessible by the first device, establishing the connection for recording between the first and second devices, verifying by the first device that the second device is on the list of trusted second devices, and recording at least a portion of the communication between the first and second devices if indicated by a user of the first device without further input from a user of the second device.

According to some embodiments of the present invention, a method for recording between a first device and a second device comprises establishing communication between the first device and the second device, requesting permission to record conversation between a user of the first device and a user of the second device, wherein permission is requested by the user of the first device through an interactive interface on the second device, receiving permission to record at the first device, and recording at least a portion of the conversation between the first and second devices.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a schematic of a communications system.

FIGS. 2A-2B are simplified views of the communications system of FIG. 1.

FIG. 3 is a flowchart of a method of recording communications between devices, according to an exemplary embodiment of the present invention.

FIG. 4 is a flowchart of a method of recording communications between devices, according to an exemplary embodiment of the present invention.

FIG. 5 is a flowchart of a method of recording communications between devices, according to an exemplary embodiment of the present invention.

FIG. 6 illustrates an interactive interface of a personal electronic device, according to an exemplary embodiment of the present invention.

FIG. 7 is a block diagram of a personal electronic device, according to an exemplary embodiment of the present invention.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

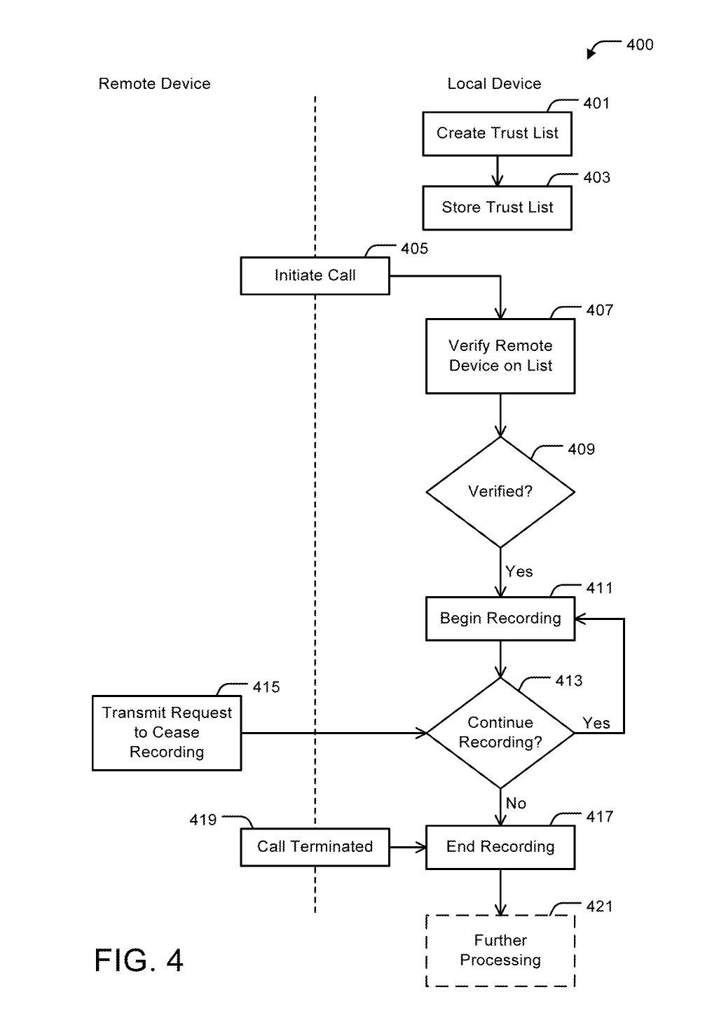

Turning to FIG. 4, a schematic of a communications system 100 is illustrated. The system 100 includes a plurality of devices 101, 102, and 103. The devices 101, 102, and 103 may be in communication with a base station subsystem (BSS) 104 over an air or Urn interface. For example, devices 101, 102, and 103 may be personal electronic devices such as cell phones or cellular-enabled electronic devices. The devices 101, 102, and 103 may intercommunicate such that telephone conversations or at least audio communications are exchanged between devices.

The BSS 104 enables communications through a plurality of base station transceivers (BTS) 141. Each BTS 141 may be in communication with base station controller (BSC) 142 over a communications channel, for example, an A-bis or BTS interoperability specification communication channel. The BSC 142 may be coupled to interface 143 allowing communication with a general network subsystem (NSS) 105 over link Gb and a core network 106 over link A. The core network may be enabled with general pack radio service (GPRS), code division multiple access (CDMA), worldwide interoperability for microwave access (WiMAX), long term evolution (LTE), global system for mobile communications (GSM), enhanced data rates for GSM evolution (EDGE), universal mobile telecommunications system (UMTS), high speed packet access (HSPA), or any combination thereof including any other suitable or desirable communications standard.

The NSS 105 and core network 106 may be in communication with each other, and may further be in communication with a public telephony switch network (PTSN) 107 having one or more telephone apparatuses 108 coupled thereto, and/or the Internet 109 having one or more computer apparatuses 110 coupled thereto, respectively.

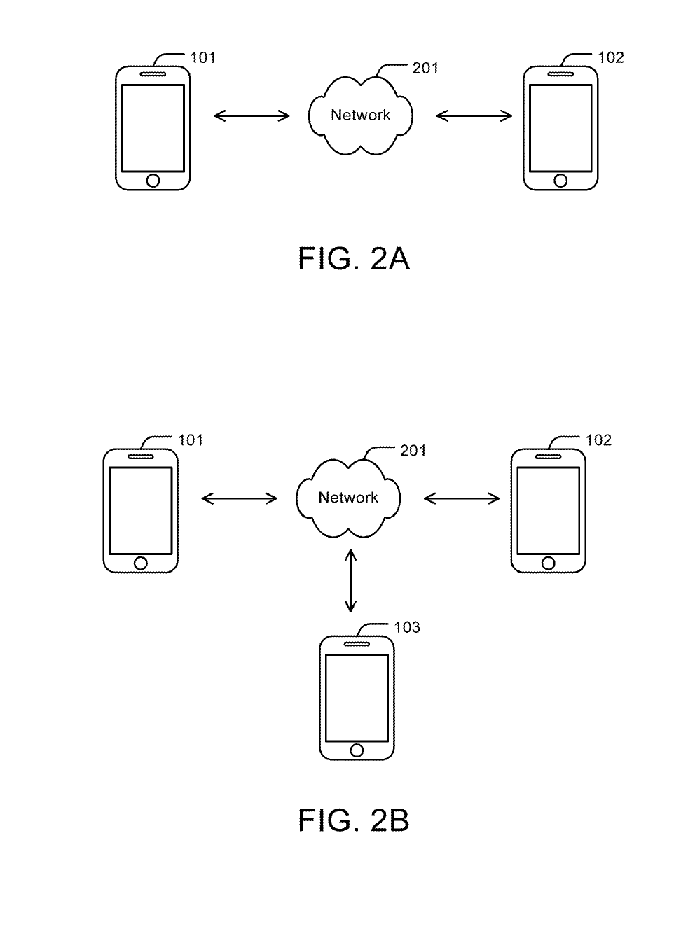

As communications are established between one or more of the device 101, 102, and 103 and the NSS 105 or core network 106, information exchange is virtually seamless. For example, phone calls and/or audio communications may be established between any device 101, 102, and 103 and telephone apparatuses 108. Similarly, audio chatting or other audio exchange services (e.g., voice over Internet protocol, real-time chatting, etc) may be established between any device 101, 102, and 103 and computer apparatuses 110. The apparent seamless communications may be illustrated in a simplified manner as shown in FIGS. 2A-2B.

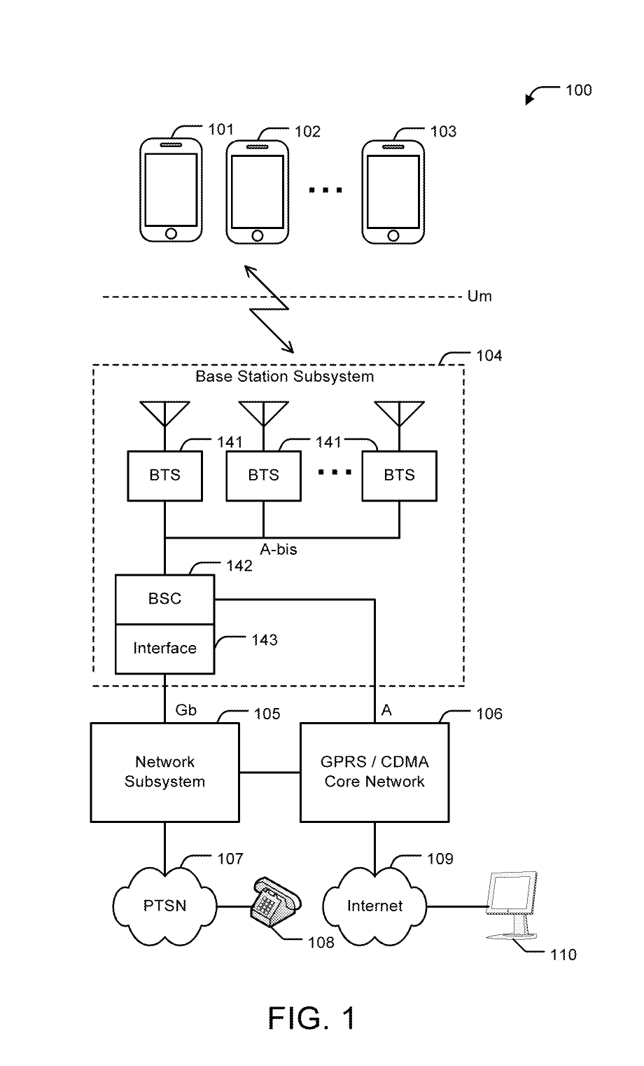

FIGS. 2A-2B are simplified views of the communications system of FIG. 1. As illustrated in FIG. 2A, devices 101 and 102 may share audio, video, and/or data information over a general network 201. Similarly, devices 101, 102, and 103 may participate in a conference call over general network 201 as illustrated in FIG. 2B. The same is extensible to any number of devices in communication with the network 201, for example, telephone apparatuses, personal computer apparatuses. laptops, personal digital assistants, tablets, and/or any other suitable or desirable device may exchange audio, video, and/or data information over general network 201. General network 201 may be a simplified example of the underlying communications network described above with reference to FIG. 1, and/or may include more or less components, communications protocols, communications mediums, or other portions according to any desired implementation of exemplary embodiments.

If it is desirable to record and/or store a portion of the communications described above, the same may be facilitated through any of the devices 101, 102, and 103. For example, one or more of the devices 101, 102, and 103 may be configured to perform a method of recording communications between devices. The recording may include audio information, for example, a portion, portions, or entirely of a telephone conversation. The recording may also include a one-sided or memorandum-styled communication including an audio listing of tasks, items, or other information, for example, a grocery list.

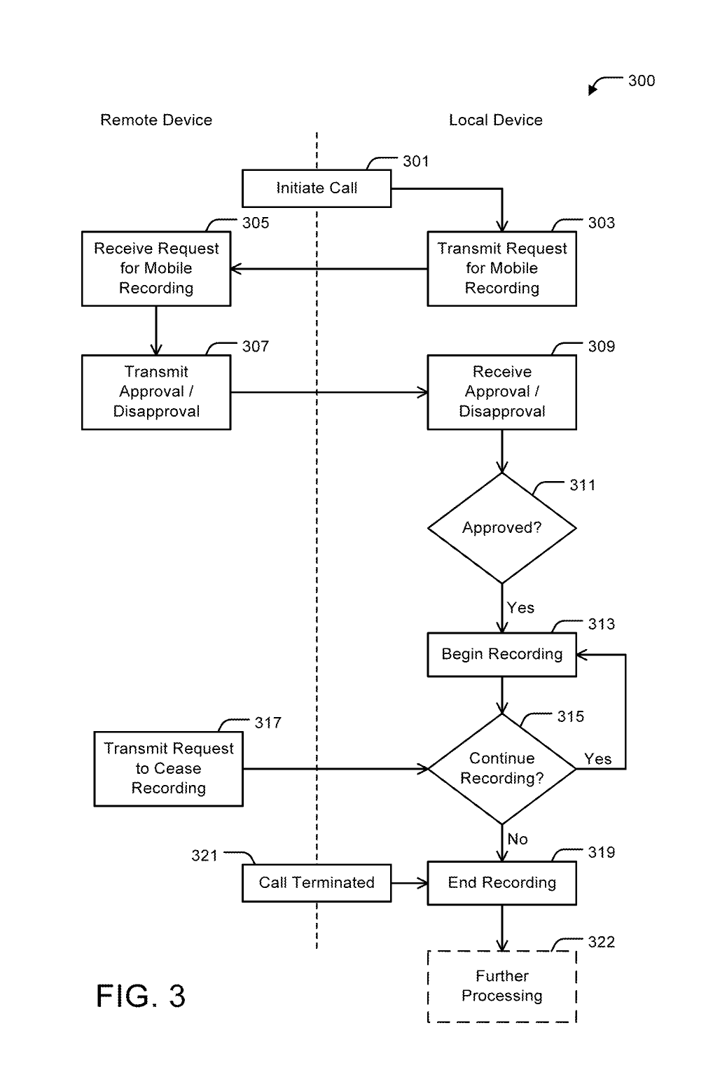

Hereinafter, a plurality of methods of recording communications between devices are described in detail with reference to FIGS. 3-5.

Turning to FIG. 3, a flowchart of a method 300 of recording communications between devices is illustrated. For ease of explanation and understanding, the method 300 has been divided across a network between a first or local device, and a second or remote device. The local device and the remote device may be embodied by any of the devices described above, including, but not limited to, devices 101, 102, 103, 108, and 110. Although particularly termed “local” and “remote”, it should be readily understood that this terminology is relative to a user of a particular device, and is considered non-limiting.

The method 300 includes initiating communication at block 301. Initiating communication may include dialing a telephone number, activating an audio chat application, transferring audio information, or any other suitable initiation of communications. The initiating may be performed by either or both of the local device and the remote device. The initiating may include accepting the initiating communication by activating a handset, lifting a handset, or accepting a telephone call request, or any other suitable gesture.

The method 300 further includes, at the local device, transmitting request for mobile recording at block 303. The transmitting may be facilitated through a communications network or other suitable network, as illustrated in FIGS. 1, 2A, and 2B. The request may be transmitted to the remote device, and may be received by the remote device at block 305. Receiving the request may include receiving the request over the communication network and displaying or producing a set of options at the remote device through an interactive user interface.

According to one exemplary embodiment of the present invention, an interactive user interface at the remote device may produce audio (e.g., via a speaker or headset) stipulating that the local device has transmitted a request for mobile device recording of a portion, portions, or entirety of the communication between the local and remote device, and may further request approval/disapproval (e.g., consent) of the request. The approval/disapproval may be facilitated through voice responses, dialing particular numbers/text on a keypad, selecting an input option, or by any other suitable mechanism.

According to one exemplary embodiment of the present invention, an interactive user interface at the remote device may render graphical cues stipulating that the local device has transmitted a request for mobile device recording of a portion, portions, or all of the communication between the local and remote device, and may further request approval/disapproval of the request. The graphical cues may be rendered on a display portion of the remote device as part of a graphical user interface or portion thereof. The graphical cues may include rendered buttons, selection portions, dials, or other cues allowing a user of the remote device to identify approval/disapproval of the mobile device recording request.

The method 300 further includes transmitting approval/disapproval of the request for mobile recording at block 307. The transmitting may be facilitated through the communications network. The approval/disapproval may be transmitted to the local device, and may be received by the local device at block 309.

Upon receipt of the approval/disapproval, the local device determines if the request for mobile recording has been approved at block 311. If approved, the method 300 includes beginning recording of at least a portion of the communications between the local device and the remote device at block 313.

Beginning recording may include initiating the transfer of audio information of the communication between the local device at the remote device to a storage portion or module of the local device. The storage portion or module may include a software application configured to sample audio, transcode the sampled audio, and store the transcoded audio at the local device. The storage portion or module may also directly or indirectly store non-transcoded audio samples. The audio information stored may include audio information received at the local device (e.g., a remote user's voice), audio information generated at the local device (e.g., a local user's voice), or any suitable combination thereof. Furthermore, individual streams of sampled audio may be stored individually, or tagged/identified in this manner during storage, such that audio information generated at the local device and audio information received at the local device may be separated, for example, for distribution as a “one-sided conversation” or memorandum for either or both of a local user and a remote user.

The method 300 further includes determining if recording should continue at block 315. For example, a request to cease recording may be transmitted by the remote device at block 317. Additionally, or alternatively, a user of the local device may issue a request to cease recording. The request to cease recording by the local or remote device may include any suitable mechanism, including voice commands, dialing or depressing keys/buttons/combinations, or any other suitable mechanism. Also, a call or communication between the local device and remote device may be terminated at block 321. In response to any of these scenarios, or any other suitable scenario including receipt of voice prompts/key presses requesting cessation of recording, the method 300 may include ending recording at block 319.

Upon cessation of recording, further processing may occur at block 322. Further processing may include audio post-processing, storage of the recording, transmittal of a portion, portions, or entirety of the recording to a user of the remote device, or any other suitable processing. Further processing may also include playback or deletion of a portion, portions, or the entirety of the recording. Further processing may also include requesting different forms of approval from the local device or remote device, including but not limited to approval for distribution, broadcast, transmission, deletion, long-term storage, transcription, or any other suitable form of approval depending upon any desirable or applicable use of a recorded communication.

It should be appreciated that although particularly described and illustrated in FIG. 3 as a telephonic communication between the local device and remote device, the same may be varied in many ways, for example, through integration with an audio chat application or direct communication transmission protocol such as cellular push-to-talk (PTT) or other similar protocols.

Furthermore, although illustrated and described as requiring real-time consent for mobile device recording (e.g., blocks 303-311), stored prior consent may also be applicable to exemplary embodiments of the present invention as described below.

FIG. 4 is a flowchart of a method 400 of recording communications between devices, according to an exemplary embodiment of the present invention. For ease of explanation and understanding, the method 400 has been divided across a network between a first or local device, and a second or remote device. The local device and the remote device may be embodied by any of the devices described above, including, but not limited to, devices 101, 102, 103, 108, and 110.

The method 400 includes creating trust list at block 401. The trust list may be a listing or selection of trusted or previously consenting devices by which presence on the list indicates permission to record a portion, portions, or entirely of a communication between the local and remote devices. The trust list may include identification of the trusted devices, by any suitable means, including but not limited to telephone numbers, usernames, login ID, mobile equipment identifier (MEID), Internet protocol (IP) address, electronic serial numbers (ESN), voice identification of one or both of a user of the local device and user of the remote device, individual key combinations entered at an analog phone, or any other suitable means for identification.

The method 400 further includes storing the trust list at block 403. Storing the trust list may include storing a current, new, or edited trust list on the local device in memory, on a storage device, or by any other suitable storage mechanism. The stored trust list may be accessible by the local device when or if a request for mobile device recording is established at the local device or at the remote device. The stored trust list may therefore establish prior consent by the identification of users on said list, and creation of the trust list may include consent acquiring protocols not illustrated in FIG. 4. The consent acquiring protocols may include transmission of a request for consent somewhat similar to block 303 illustrated in FIG. 3, for example, by requesting “future consent” for mobile device recording between the local device and remote device, or requesting placement from the remote device onto the local device's trust list.

Upon request for mobile device recording by either the local or remote device (not illustrated for clarity), or by initiating a communication at block 405, the method 400 may include verifying if a remote device is part of the trust list at block 407. If verified at block 409, the method 400 includes beginning recording of at least a portion of the communications between the local device and the remote device at block 411. Initiating communication may include dialing a telephone number, activating an audio chat application, transferring audio information, or any other suitable initiation of communications. The initiating may be performed by either or both of the local device and the remote device. The initiating may include accepting the initiating communication by activating a handset or accepting a telephone call request, or any other suitable gesture. The request for mobile device recording may include selection of an interface option, depressing a record request input button, or any other suitable form of request at either the local device or remote device.

Beginning recording at block 411 may include initiating the transfer of audio information of the communication between the local device at the remote device to a storage portion or module of the local device. The storage portion or module may include a software application configured to sample audio, transcode the sampled audio, and store the transcoded audio at the local device. The storage portion or module may also directly or indirectly store non-transcoded audio samples. The audio information stored may include audio information received at the local device (e.g., a remote user's voice), audio information generated at the local device (e.g., a local user's voice), or any suitable combination thereof. Furthermore, individual streams of sampled audio may be stored individually, or tagged/identified in this manner during storage, such that audio information generated at the local device and audio information received at the local device may be separated, for example, for distribution as a “one-sided conversation” or memorandum for either or both of a local user and a remote user.

The method 400 further includes determining if recording should continue at block 413. For example, a request to cease recording may be transmitted by the remote device at block 415. Additionally, or alternatively, a user of the local device may issue a request to cease recording. Also, a call or communication between the local device and remote device may be terminated at block 419. In response to any of these scenarios, or any other suitable scenario including receipt of voice prompts/key presses requesting cessation of recording, the method 400 may include ending recording at block 417.

Upon cessation of recording, further processing may occur at block 421. Further processing may include audio post-processing, storage of the recording, transmittal of a portion, portions, or entirety of the recording to a user of the remote device, or any other suitable processing. Further processing may also include playback or deletion of a portion, portions, or the entirety of the recording. Further processing may also include requesting different forms of approval from the local device or remote device, including but not limited to approval for distribution, broadcast, transmission, deletion, long-term storage, transcription, or any other suitable form of approval depending upon any desirable or applicable use of a recorded communication.

It should be appreciated that although particularly described and illustrated in FIG. 4 as a telephonic communication between the local device and remote device, the same may be varied in many ways, for example, through integration with an audio chat application or direct communication transmission protocol such as cellular push-to-talk (PTT) or other similar protocols.

Furthermore, although illustrated and described as requiring stored prior consent through use of a trust list or verification of devices (e.g., blocks 401-409), implied consent may also be applicable through a request initiated at a remote device as described below.

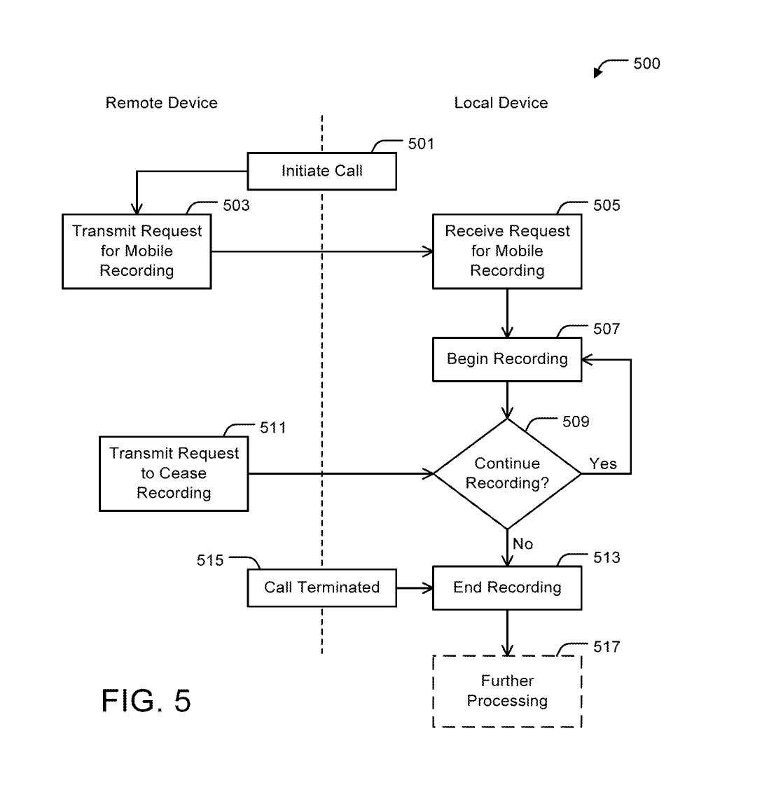

FIG. 5 is a flowchart of a method of recording communications between devices, according to an exemplary embodiment of the present invention. For ease of explanation and understanding, the method 500 has been divided across a network between a first or local device, and a second or remote device. The local device and the remote device may be embodied by any of the devices described above, including, but not limited to, devices 101, 102, 103, 108, and 110.

The method 500 includes initiating communication at block 501. Initiating communication may include dialing a telephone number, activating an audio chat application, transferring audio information, or any other suitable initiation of communications. The initiating may be performed by either or both of the local device and the remote device. The initiating may include accepting the initiating communication by activating a handset or accepting a telephone call request, or any other suitable gesture.

The method 500 further includes, at the remote device, transmitting a request for mobile recording at block 503. The transmitting may be facilitated through a communications network or other suitable network, as illustrated in FIGS. 1, 2A, and 2B. The request may be transmitted to the local device, and may be received by the local device at block 505. According to one exemplary embodiment of the present invention, transmittal of the request by the remote device establishes implied consent for mobile device recording at the local device. Alternatively, authorization may be verified through use of a trust list as described above, or through transmittal of a consent request by the local device to the remote device.

Upon receipt of the request at block 505, or upon verification of consent through other means, the method 500 includes beginning recording of at least a portion of the communications between the local device and the remote device at block 507.

Beginning recording may include initiating the transfer of audio information of the communication between the local device at the remote device to a storage portion or module of the local device. The storage portion or module may include a software application configured to sample audio, transcode the sampled audio, and store the transcoded audio at the local device. The storage portion or module may also directly or indirectly store non-transcoded audio samples. The audio information stored may include audio information received at the local device (e.g., a remote user's voice), audio information generated at the local device (e.g., a local user's voice), or any suitable combination thereof. Furthermore, individual streams of sampled audio may be stored individually, or tagged/identified in this manner during storage, such that audio information generated at the local device and audio information received at the local device may be separated, for example, for distribution as a “one-sided conversation” or memorandum for either or both of a local user and a remote user.

The method 500 further includes determining if recording should continue at block 509. For example, a request to cease recording may be transmitted by the remote device at block 511. Additionally, or alternatively, a user of the local device may issue a request to cease recording. Also, a call or communication between the local device and remote device may be terminated at block 515. In response to any of these scenarios, or any other suitable scenario including receipt of voice prompts/key presses requesting cessation of recording, the method 500 may include ending recording at block 513.

Upon cessation of recording, further processing may occur at block 517. Further processing may include audio post-processing, storage of the recording, transmittal of a portion, portions, or entirety of the recording to a user of the remote device, or any other suitable processing. Further processing may also include playback or deletion of a portion, portions, or the entirety of the recording. Further processing may also include requesting different forms of approval from the local device or remote device, including but not limited to approval for distribution, broadcast, transmission, deletion, long-term storage, transcription, or any other suitable form of approval depending upon any desirable or applicable use of a recorded communication.

It should be appreciated that although particularly described and illustrated in FIG. 5 as a telephonic communication between the local device and remote device, the same may be varied in many ways, for example, through integration with an audio chat application or direct communication transmission protocol such as cellular push-to-talk (PTT) or other similar protocols.

Additionally, it should be appreciated that any portions or all of the methodologies described above may be combined to form new interactive mobile recording solutions, including direct consent, prior stored consent, implied consent, trust lists, distribution, long-term storage, playback, or any other solution. Similarly, consent protocols may be used after a recording has been stored to enable recording without prior consent, and request for consent to store and/or distribute portions or all of the recording after or during an actual recording. For example, if a local or remote user initiates mobile device recording without consent, the actual device may begin recording without consent, if applicable, and later seek consent before user playback and/or distribution may occur. In this manner, a plurality of mobile device recording solutions may be enabled and supported by exemplary embodiments of the present invention.

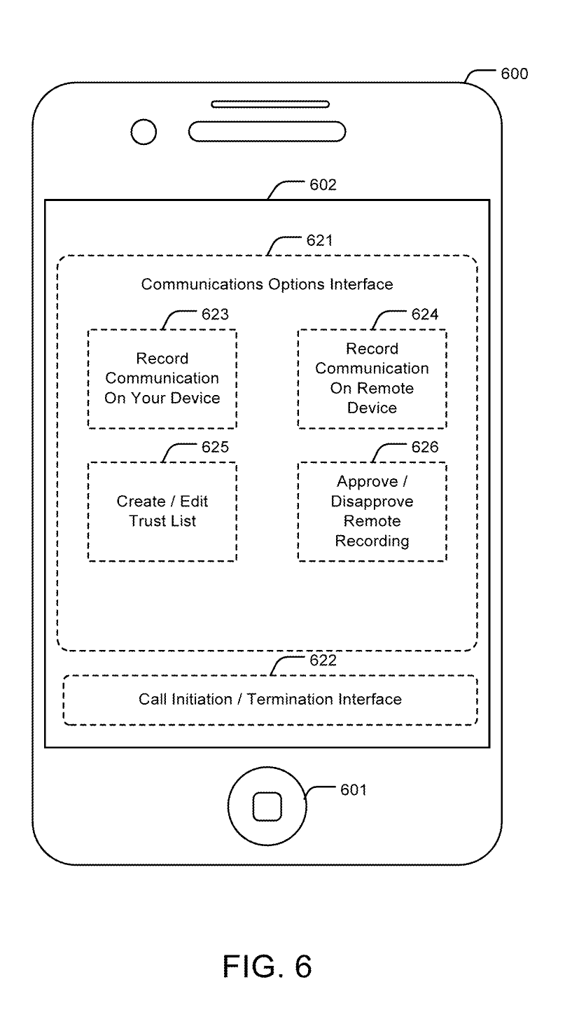

As described above, interactive user interfaces at one or both of the local device and remote device may be used to request mobile device recording, consent to mobile device recording, request to cease recording, and perform other functions. FIG. 6 illustrates an interactive interface of a personal electronic device 600, according to an exemplary embodiment of the present invention. The personal electronic device 600 may be similar to any of the devices described above, including, but not limited to, devices 101, 102, 103, and 110.

As shown, the device 600 includes a button interface 601 and a display portion 602. The button interface 601 may include one or more physical buttons, software-enabled buttons, capacitive-sensing buttons, or other devices configured to perform a function during operation of the device 600.

The display portion 602 may render any number of graphical cues, including a communications options interface 621 and a call/communication initiation/termination interface 622. The communications options interface 621 may include a plurality of graphical selections configured to enable one or more portions of any of the methodologies described herein. For example, the communications options interface 621 may include a ‘record communication on your device’ option 623 which enables mobile device recording on a local (e.g., your) device (e.g., see FIGS. 3 and 4). The communications options interface 621 may further include a ‘record communication on remote device’ option 624 which enables a request for mobile device recording on a separate device in communication therewith (e.g., see FIG. 5). The communications options interface 621 may further include a ‘create/edit trust list’ option 625 which enables creation and editing a trust list as described with reference to FIG. 4. Furthermore, the communications options interface 621 may further include an ‘approve/disapprove remote recording’ option 626 to handle received requests for mobile device recording.

It is noted that although illustrated as referring to “your” and “remote” devices, these terms are relative to a user of the device 600. The same may be interchanged depending upon any desired implementation of exemplary embodiments.

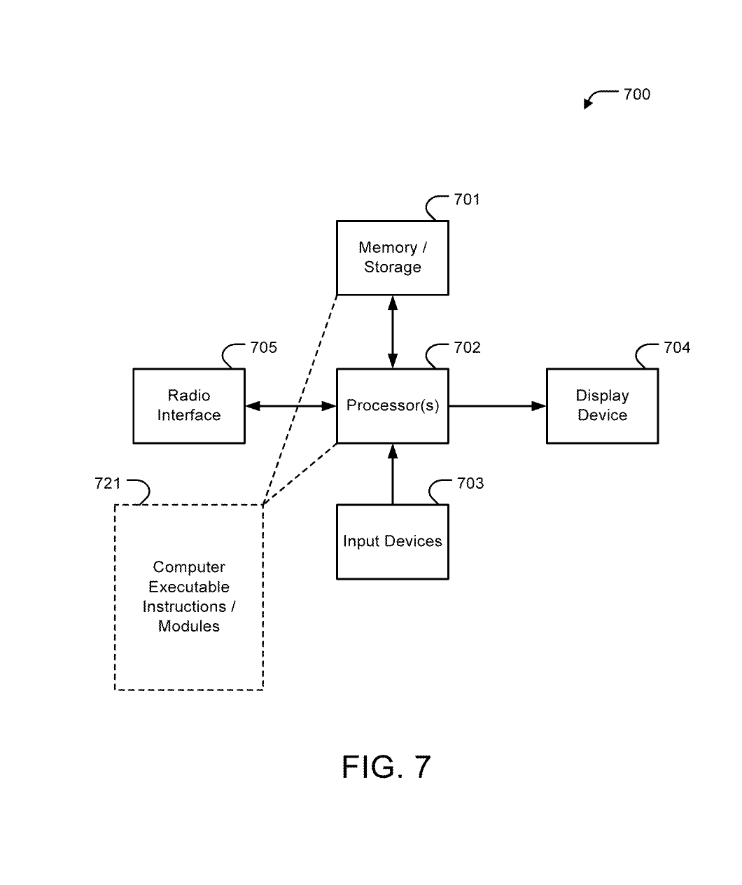

As described above, the interactive user interfaces at one or both of the local device and remote device may be used to facilitate portions or the entirety of the methods of mobile device recording described above. These methods may be embodied wholly or in part as computer executable instructions/modules/applications 721 existing on a processor 702 and/or memory/storage 701 (e.g., computer readable storage mediums) of a personal electronic device 700, as illustrated in FIG. 7. The device 700 may also include input devices 703 and display devices 704 for rendering graphics and handling user input. The device 700 may further include a communications or radio interface 705 to facilitate communications over a general network 201 as described above. The radio interface 705 may be any suitable interface, including hard-wired or non-radio network interfaces if desired.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling or storing portions of communications or as computer readable code on a computer readable medium for controlling or storing portions of communications. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method for recording at least a portion of a communication between a first device and a second device, the method comprising:
establishing a connection between the first device and the second device;
performing, by the first device, a voice recognition of a user of the second device;
determining, based on the voice recognition, that consent exists from the user of the second device to record the at least a portion of the communication;
recording, at the first device, the at least a portion of the communication; and
storing the recording.

2.-5. (canceled)

6. The method of claim 1, further comprising:
attempting, at the first device, to distribute the recording; and
requesting, at the first device and via one or more consent acquiring protocols, consent from the second device to distribute the recording.

7.-8. (canceled)

9. The method of claim 1, wherein recording the at least a portion of the communication between the first device and the second device comprises:
beginning audio sampling of a communication between the first device and the second device; and
storing the audio sampling of the communication.

10. The method of claim 9, wherein storing the recording further comprises transcoding the audio sampling prior to storing the audio sampling.

11. The method of claim 1, wherein the first device is a personal electronic device or cellular telephone.

12. A method for recording at least a portion of a communication between a first device and a second device, the method comprising:
establishing the communication between the first device and the second device;
requesting permission to record the at least a portion of the communication between a user of the first device and a user of the second device, wherein the permission is requested by the user of the first device an interactive interface displayed on the second device;
receiving, from the second device and via the interactive display, permission to record the at least a portion of the communication at the first device;
recording the at least a portion of the communication between the first device and the second device; and
storing the recording as a first stream and a second stream, wherein the first stream solely comprises audio data originating from the first device and the second stream solely comprises audio data originating from the second device.

13. The method of claim 12, wherein establishing the communication between the first device and the second device comprises initiating a telephone call.

14. The method of claim 12, wherein requesting permission to record the at least a portion of the communication comprises transmitting, from the first device, a request for permission to record the at least a portion of the communication.

15. The method of claim 14, further comprising:
receiving, at the second device, the request for permission to record the at least a portion of the communication; and
generating, at the second device, a prompt to consent to recording.

16. The method of claim 15, wherein the prompt to consent to recording comprises one of:
a graphical cue rendered on a display portion of the second device; and
an audio cue generated by an audio portion of the second device.

17. The method of claim 16, wherein the graphical cue comprises:
a graphical user interface rendering that displays the request for permission to record the at least a portion of the communication; and
a graphical user interface input portion that allows the user of the second device to input consent.

18. The method of claim 16, wherein the audio cue comprises:
an audio segment explanatory of the request for permission to record the at least a portion of the communication, and the permission is received from the second device when the user of the second device issues a voice response that indicates consent to record the at least a portion of the communication.

19. The method of claim 12, wherein recording the at least a portion of the communication between the first device and second the device comprises:
beginning audio sampling of the at least a portion of the communication between the first device and second the device; and
storing the audio sampling of the communication.

20. The method of claim 19, wherein storing the recording further comprises transcoding the audio sampling prior to storing the audio sampling.

21. The method of claim 1, wherein storing the recording comprises separating the at least a portion of the communication into a first stream and a second stream, wherein the first stream solely comprises audio data originating from the first device and the second stream solely comprises audio data originating from the second device.

22. A non-transitory computer readable storage medium storing instructions that, when executed by a processor of a first device, cause the first device to implement a method for recording at least a portion of a communication between the first device and a second device, the method comprising:
establishing a connection between the first device and the second device;
performing, by the first device, a voice recognition of a user of the second device;
determining, based on the voice recognition, that consent exists from the user of the second device to record the at least a portion of the communication;
recording, at the first device, the at least a portion of the communication;
storing, at the first device, the recording;
attempting, at the first device, to play back or distribute the recording; and
requesting, at the first device and via one or more consent acquiring protocols, consent from the second device to play back or distribute the recording.

23. The medium of claim 22, wherein recording the at least a portion of the communication between the first device and the second device comprises:
beginning audio sampling of a communication between the first device and the second device; and
storing the audio sampling of the communication.

24. The medium of claim 23, wherein the recording further comprises transcoding the audio sampling prior to storing the audio sampling.

25. The medium of claim 22, wherein the first device is a personal electronic device or cellular telephone.
